(19) United States
(12) Patent Application Publication
(10) Pub. No.: US 2022/0327352 A1
(43) Pub. Date: Oct. 13, 2022

(54) SYSTEMS AND METHODS FOR PROVIDING EXPLANATION FOR BLACK BOX ALGORITHMS

(71) Applicant: Walmart Apollo, LLC, Bentonville, AR (US)

(72) Inventors: Anindya S. Dey, Bentonville, AR (US); Shangwen Huang, Rogers, AR (US); Yifan Wang, Bentonville, AR (US); Xunzhao Yin, Olathe, KS (US)

(21) Appl. No.: 17/227,180

(22) Filed: Apr. 9, 2021

(51) Int. Cl. G06N 3/02; G06N 5/00; G06K 9/62

(52) U.S. Cl. CPC G06N 3/02; G06N 5/003; G06K 9/6202; G06K 9/6231; G06K 9/6298

(57) ABSTRACT

Systems, apparatuses, and methods are provided herein for providing natural language explanation to black-box algorithm generated outcome. The system is configured to determine a regression coefficient for each of the plurality of attributes based regression analysis, determine a decision tree based on the input data and the output data and a decision path of a select data item in the decision tree, generate natural language explanation of a categorization of the select data item based on the relevant attributes and regression coefficients associated with each of the relevant attributes, wherein the natural language explanation identifies at least one relevant attribute and an effect of the at least one relevant attribute of the data item on the categorization, and transmit to a user interface device for display, the categorization of the select data item along with the natural language explanation of the categorization of the select data.

### TECHNICAL FIELD

This invention relates generally to an automated explanation system for black box algorithms.

### BACKGROUND

Machine learning (ML) generally refers to an application of artificial intelligence (AI) that provides systems with the ability to make predictions or decisions based on training data without being explicitly programmed to do so. ML is increasingly being used to support high-consequence human decisions.

### BRIEF DESCRIPTION OF THE DRAWINGS

Disclosed herein are embodiments of apparatuses and methods for providing explanations for black box algorithms. This description includes drawings, wherein:

FIG. 1 comprises a block diagram of a system in accordance with some embodiments;

FIG. 2 comprises a flow diagram in accordance with some embodiments;

FIG. 3 comprises a flow diagram in accordance with some embodiments;

FIG. 4 comprises a process diagram in accordance with some embodiments;

FIG. 5 comprises an illustration of a decision tree model in accordance with some embodiments;

FIG. 6 comprises a table of example data set in accordance with some embodiments; and

FIG. 7 comprises an example user interface in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein for providing natural language explanation to black box algorithm-generated outcome. In some embodiments, a system comprises an input data database storing input data comprising a plurality of data items, each data item comprises a plurality of attributes, an output data database storing output data comprising categorizations of the plurality of data items determined by an algorithm based on attributes of the plurality of data items, and a control circuit coupled to the input data database and the output data database. The control circuit is configured to determine a regression coefficient for each of the plurality of attributes based on performing regression analysis on the output data, determine a decision tree based on the input data and the output data, the decision tree comprises a plurality of nodes each associated with an attribute of the plurality of attributes, determine a decision path of a select data item in the decision tree, the decision path comprises a subset of the plurality of nodes corresponding to relevant attributes of the select data item, generate natural language explanation of a categorization of the select data item based on the relevant attributes and regression coefficients associated with each of the relevant attributes, wherein the natural language explanation identifies at least one relevant attribute and an effect of the at least one relevant attribute of the data item on the categorization, and transmit to a user interface device for display, the categorization of the select data item along with the natural language explanation of the categorization of the select data.

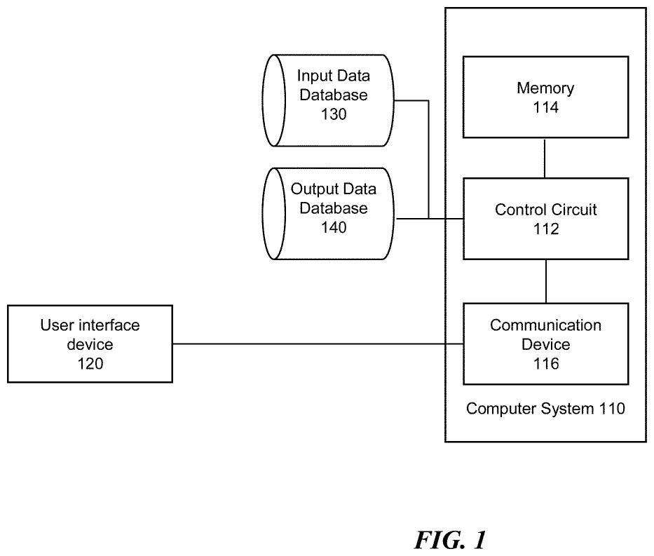

Referring now to FIG. 1, a system for providing natural language explanation for the output of a computer algorithm is shown. The computer system 110 is coupled to an input data database 130, output data database 140, and a user interface device 120.

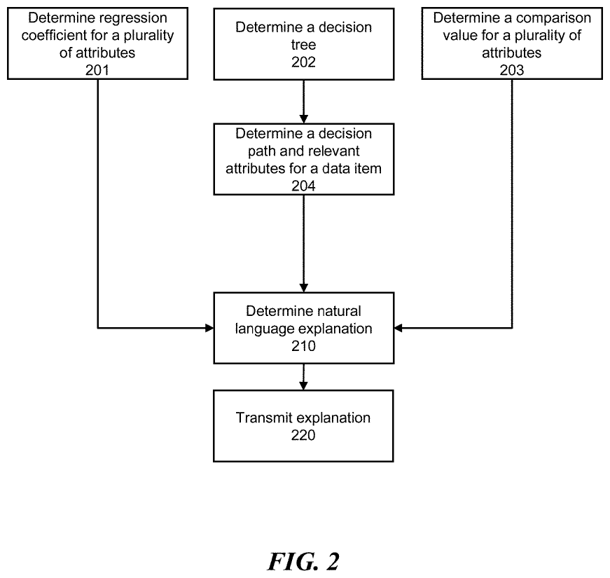

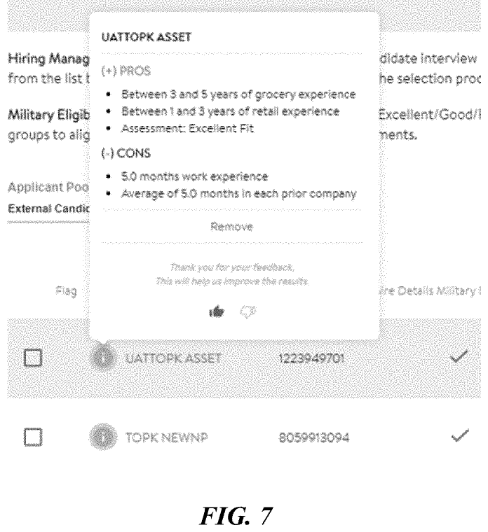

The computer system 110 comprises a control circuit 112, a memory 114, and a communication device 116. The computer system 110 may comprise one or more of a server, a central computing system, a desktop computer system, a personal computer, a portable device, and the like. The control circuit 112 may comprise a processor, a microprocessor, a central processing unit (CPU), a graphics processing unit (GPU), an application-specific integrated circuit (ASIC), and the like and may be configured to execute computer-readable instructions stored on a computer-readable storage memory 114. The computer-readable storage memory 114 may comprise volatile and/or non-volatile memory and have stored upon it, a set of computer-readable instructions which, when executed by the control circuit 112, causes the computer system 110 to provide natural language explanation to the output data in the output data database 140 that is generated by an algorithm based on the input data in the input data database 130. In some embodiments, the algorithm may be a black box algorithm that does not provide information on its internal workings, such as artificial intelligence machine learning algorithms. In some embodiments, the algorithm may be an unknown computer algorithm without available source code. In some embodiments, the computer-executable instructions may cause the control circuit 112 of the computer system 110 to perform one or more steps described with reference to FIGS. 2-4 herein. In some embodiments, the computer-executable instructions may cause the control circuit 112 of the computer system 110 to provide a user interface for viewing and interacting with the generated natural language explanation, such as the user interface described with reference to FIG. 7. In some embodiments, the memory 114 may further store the black box algorithm executable by the control circuit.

The communication device 116 may comprise a data port, a wired or wireless network adapter, and the like. In some embodiments, the computer system 110 may communicate with the user interface device 120 over a network such as a local network or the Internet. The user interface device 120 comprises user input/output devices such as a keyboard, a mouse, a touch screen, a display screen, a VR/AR display device, a speaker, a microphone, etc. In some embodiments, the user interface device 120 may be a processor-based standalone user device such as a personal computer, a desktop computer, a laptop computer, a mobile device, a smartphone, and the like. The user interface device 120 may execute an application for displaying black box algorithm results and natural explanation provided by the computer system 110. In some embodiments, the user interface device 120 may comprise the i/o user interface of the computer system 110 executing the program for generating natural language explanation. In some embodiments, the black box algorithm itself may also be executed on the computer system 110, and the output of the black box algorithm may be generated and viewed along with the output of the natural language explanation system via the user interface device 120.

The input data database 130 comprises a computer-readable memory storage storing input data comprising a plurality of data items. Each data item comprises a plurality of attributes or features. For example, data items in the input data may represent products and each data item has a plurality of associated product attributes such as name, size, weight, manufacturer, category, price, and the like. In another example, the data items in the input data may represent job applicants or personnel and each data item has a plurality of associated worker attributes such as address, work history, experience, location, schedule availability, and the like. The output data database 140 comprises a computer-readable memory storage storing output of an algorithm that is generated based on the input data. In some embodiments, the output data comprises categorizations of the plurality of data items in the input data database 130 determined by an algorithm based on attributes of the plurality of data items. For example, the output data may comprise estimated product demand. In another example, the output data may comprise scorings of job applicants. In some embodiments, the input data database 130 and the output data database 140 may be combined into a single database. For example, when an algorithm determines a categorization of a data item, the categorization value may be added as a label of the data item in the database. FIG. 6 illustrates an example database in which each row corresponds to a data item, features 1-4 corresponds to attributes of data items, and “classification prob” corresponds to the computer algorithm-determined output for each data item.

While one computer system 110 is shown, in some embodiments, the functionalities of the computer system 110 may be implemented on a plurality of processor devices communicating on a network. In some embodiments, the computer system 110 may be coupled to a plurality of user interface devices 120 and simultaneously support multiple instances of the user interface application on each user interface device to display natural language explanations.

Referring now to FIG. 2, a method for providing natural language explanation to algorithm-generated output is shown. In some embodiments, the steps shown in FIG. 2 may be performed by a processor-based device such as a control circuit executing a set of computer-readable instructions stored on a computer-readable memory. In some embodiments, one or more steps of FIG. 2 may be performed by the computer system 110 described with reference to FIG. 1 herein or a similar device.

In some embodiments, prior to the steps shown in FIG. 2, the system retrieves a set of input data and a set of output data generated by an algorithm based on the input data. In some embodiments, the input data comprises a plurality of data items, and each data item comprises a plurality of attributes. In some embodiments, the output data comprises categorizations of the plurality of data items determined by an algorithm based on attributes of the plurality of data items. In some embodiments, the algorithm comprises a black box algorithm the decision logic of which is not known to the system. In some embodiments, the algorithm may comprise an AI and/or ML algorithm such as an artificial neural network algorithm.

In Step 201, the system performs regression analysis on a set of input data and output data generated by an algorithm to determine regression coefficients for attributes of the data items in the input data. In some embodiments, the regression coefficient comprises a sign indicating whether the attribute has a positive or negative effect on the categorization (e.g. score, ranking) of the data item. For example, an attribute that has a positive correlation to the categorization may have a positive regression coefficient. In some embodiments, the regression coefficient comprises a numerical value indicating the significance of the attribute to the output. In some embodiments, regression coefficients of numerical attributes are determined based on linear regression and regression coefficients of categorical attributes are determined based on logistic regression.

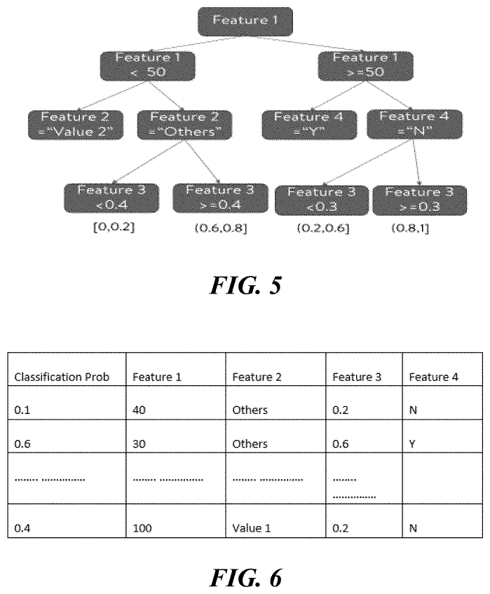

In step 202, the system determines a decision tree based on the input data and the output data. The decision tree may comprise a plurality of nodes each associated with an attribute of the data items and a plurality of leaves each associated with a categorization or a range of categorizations in the output data. In some embodiments, each node has an associated threshold. In some embodiments, one or more paths to a leaf of the decision tree may include only a subset of the attributes that are relevant to that decision path. In some embodiments, the decision tree may be a classification tree with discrete categorical outcomes or a regression tree with ranges of numerical outcomes. In some embodiments, the decision tree may be determined based on a classification and regression tree (CART) algorithm, a Chi-square automatic interaction detection (CHAID) algorithm, an Interactive Dichotomizer (ID3 or C4.5) algorithm, a condition inference tree, and the like. In some embodiments, the system may select the attribute and threshold value that most reduces entropy (e.g. Gini impurity) or increase information gain at each node to model the decision tree based on the input and output data. In some embodiments, the order of the nodes on a decision path corresponds to the importance of each attributes to the output categorization. An example of a decision tree according to some embodiments is described with reference to FIG. 5.

In step 203, the system determines a comparison value for at least some of the attributes of the data items. In some embodiments, the comparison value may be a peer average value of an attribute among the input data set or a subset of the input data set sharing one or more other attributes. For example, the peer average of credit history length of credit card applicants may be determined based on all applicant data or only based on applicants of similar age and/or demographic. In some embodiments, the comparison value may comprise a mean, mode, or median value. In some embodiments, the threshold value may be determined based on the threshold value of the corresponding node in the decision tree. In some embodiments, the threshold value may be determined based on user feedback on the data item categorization and/or natural language explanation.

Once the attribute regression coefficients, the decision tree, and the attribute comparison values are determined, the system may determine natural language explanations for a select data item.

In step 204, for a select data item, the system determines the decision path associated with the data item in the decision tree determined in step 202. For example, for the first data item in FIG. 6, the decision path of the decision tree model shown in FIG. 5, the decision path includes feature 1, feature 2, and feature 3, but not feature 4. The system further determines attributes relevant/significant to the categorization of the data item based on the decision path. In some embodiments, the system may select a predetermined number of attributes from the attributes on the decision path as the relevant attributes to proceed to step 220. In some embodiments, the selected attributes may be the first n number of attributes on the decision path of the data item. In some embodiments, step 204 may be repeated for a plurality of data items in the input data.

In step 210, the system generates natural language explanation of a categorization of the select data item based on the relevant attributes and regression coefficients associated with each of the relevant attributes. In some embodiments, the natural language explanation identifies at least one relevant attribute and an effect of at least one relevant attribute of the data item on the categorization. In some embodiments, the effect of the at least one relevant attribute of the data item on the categorization is determined based on the regression coefficient of the at least one relevant attribute and comparing a value of the at least one relevant attribute of the data item with a comparison value of the at least one relevant attribute in the input data database. For example, the attribute may have a positive or a negative effect on the categorization based on whether the regression coefficient is positive or negative, and whether the attribute value is above or below the comparison value. That is, for an attribute with a positive regression coefficient, an attribute value greater than the comparison value would have a positive effect on the categorization, and an attribute value lesser than the comparison value would have a negative effect on the categorization. For an attribute with a negative regression coefficient, an attribute value greater than the comparison value would have a negative effect on the categorization, and an attribute value lesser than the comparison value would have a positive effect on the categorization.

In some embodiments, the natural language explanation comprises a list of positive attributes and a list of negative attributes sorted based on whether the attributes affected the categorization of the select data item positively or negatively. For example, for an attribute associated with length of work experience and the regression coefficient is positive, if the value exceeds the comparison value (e.g. peer average), the natural language explanation may indicate that the attribute is positive (e.g. “Pro—five years of work experience”). In another example, for an attribute associated with length of work experience and the regression coefficient is positive, if the value exceeds the comparison value, the natural language explanation may indicate that the attribute is positive (e.g. “Pro—five years of work experience”). In some embodiments, the system may access an explanation text table comprising text strings associated with each of the plurality of attributes, wherein one or more attributes are associated with a plurality of text strings. The system may select from among the plurality of text strings associated with the at least one relevant attribute based on how (e.g. positive or negative) the attribute affects the categorization of the select data. For example, an attribute may be associated with a first text string this is selected when the data item attribute value is above the comparison value (e.g. “has retail experience”) and a second text string that is selected when the data item attribute value is below the peer average (e.g. “no significant retail experience). In some embodiments, text strings in the explanation text table comprise a value field, and the control circuit is configured to populate the value field of a selected text string based on a value of the at least one relevant attribute of the data item. For example, for the attribute of retail experience, if the value is 3, the text explanation may be “3 years of retail experience.” In some embodiments, the natural language explanation may comprise a text string for each relevant attribute selected in step 204. In some embodiments, the natural language explanation may include a text string that references two or more attributes. In some embodiments, the natural language explanation may comprise a list of text strings or prose descriptions referring to one or more attributes.

In step 220, the system transmits the natural language explanation of the categorization of the select data to a user interface for display. In some embodiments, the user interface may comprise the user interface device 120 described with reference to FIG. 1. In some embodiments, a user interface provides a graphical user interface for viewing the output of the algorithm. The user may select data item records to view the natural language explanation of the data item categorization provided by the system. In some embodiments, the graphical user interface may further comprise a feedback option for users to provide feedback on the explanation and/or the categorization. The feedback may be used to refine the categorization and/or the explanation. An example of the graphical user interface is described herein with reference to FIG. 7.

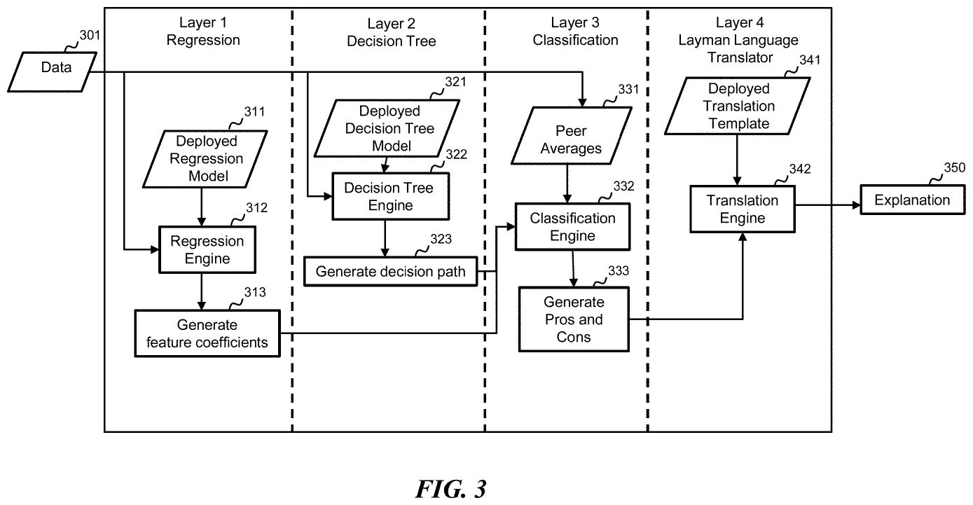

Referring now to FIG. 3, a method for providing natural language explanation to algorithm output is provided. In some embodiments, the steps shown in FIG. 3 may be performed by a processor-based device such as a control circuit executing a set of computer-readable instructions stored on a computer-readable memory. In some embodiments, one or more steps of FIG. 3 may be performed by the control circuit 112 of the computer system 110 described with reference to FIG. 1 herein or a similar device.

In layer 1, the regression engine 312 uses the regression model 311 and generates feature coefficients 313 for a plurality of data attributes in the input and output data 301. In some embodiments, the regression coefficient may indicate whether an attribute is significant to the algorithm's decision. In some embodiments, the regression coefficient may indicate whether the attribute has a positive or negative effect on the decision. In some embodiments, the regression engine 312 uses a linear regression model for attributes with continuous numerical values (e.g. weight, size) and uses a logistic regression model for attributes with categorical values (e.g. brand, color, department).

In layer 2, the decision tree engine 322 forms a decision tree based on a decision tree model 321. The decision tree is then used to determine the decision path 323 of a data item in the decision tree. In some embodiments, the decision tree may be determined based on a classification and regression tree (CART) algorithm, a Chi-square automatic interaction detection (CHAID) algorithm, an Interactive Dichotomizer (ID3 or C4.5) algorithm, a condition inference tree, and the like. In some embodiments, the decision tree comprises sequences of decision nodes each with a threshold value that determines which path a data item takes. In some embodiments, nodes on a data path that a data item goes through in the decision tree represent attributes that are important to the categorization of data item. In some embodiments, the important attributes may be different for different data items. In some embodiments, in the decision path of data item, the importance of each node is in order of importance to the categorization outcome (i.e. first node being the most important, second node being second in importance etc.).

In layer 3, for a data item, the classification engine 332 uses the feature coefficients 313 from layer 1, the decision path 323 from layer 2, and the peer average values 331 to determine whether to describe an attribute as a pro or a con in the natural language explanation of the data item's categorization. In some embodiments, the pros and cons correspond to the strengths and weaknesses of the data item (e.g. job application).

As an example, a data item may correspond to a 20-year-old male with 2 years of credit history applying for a premium credit card, and an algorithm rejected the application. In layer 1, the system may determine a positive regression coefficient to the attribute of credit history. In layer 2, the system may determine that credit history is a relevant attribute on the decision path of the applicant. In layer 3, the system may determine that 2 years of credit history is shorter than the average credit history of a 20-year-old male. Based on these determinations, the system may then determine that credit history is a con/weakness of the applicant that led to the rejection of his credit card application.

In layer 4, a translation engine 342 uses the pro/con determination to select and populate translation templates 341 to generate natural language explanation for one or more relevant attributes. For example, the translation engine may select from or populate a text string with the attribute value of a data item (e.g. “applicant has [5] years of work experience,” “product has a short shelf live”). The natural language explanation 350 is then provided to a user via a user device. The explanation for a data item may include texts associated with a plurality of attributes and indicate whether each attribute is a pro or a con toward the categorization of the data item.

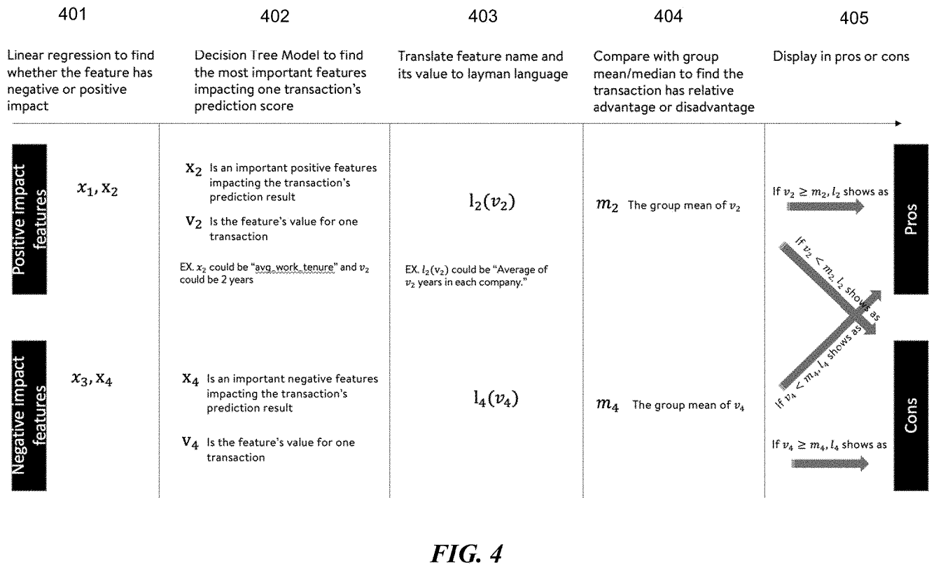

Referring now to FIG. 4, an example process for providing natural language explanation to algorithm output is provided. In some embodiments, the steps shown in FIG. 4 may be performed by a processor-based device such as a control circuit executing a set of computer-readable instructions stored on a computer-readable memory. In some embodiments, one or more steps of FIG. 4 may be performed by the control circuit 112 of the computer system 110 described with reference to FIG. 1 herein or a similar device.

In step 401, attributes x₁, x₂, x₃, and x₄ are each identified as either a positive impact feature or a negative impact feature based on applying linear regression to the input and output data of an algorithm. Generally, features refer to attributes of a data item.

In step 402, for a data item such as a transaction, the important features are identified as x₂ having value v₂ and x₄ having value v₄. In step 403, the feature name and value are translated into natural language. In some embodiments, the translation may comprise retrieving language corresponding to a feature from a template. For example, l₂ may be populated with v₂ to output the text string “average of 3 years in each company.”

In step 404, values of the important features (e.g. v₂ and v₄) are compared with group mean or median to determine whether the transaction has a relative advantage or disadvantage for each important feature. In step 405, if the value of a positive impact feature (e.g. v₂) is greater than or equal to the group mean/median, the feature is displayed as an advantage (i.e. “pro”) in the natural language explanation. If the value of a positive impact feature (e.g. v₂) is less than the group mean/median, the feature is displayed as a disadvantage (i.e. “con”) in the natural language explanation. If the value of a negative impact feature (e.g. v₄) is less than the group mean/median, the feature is displayed as an advantage (e.g. “pro”) in the natural language explanation. If the value of a negative impact feature (e.g. v₂) is greater or equal to the group mean/median, the feature is displayed as a disadvantage (e.g. “con”) in the natural language explanation.

Next referring to FIGS. 5 and 6, an example decision tree and data set are shown. The decision tree in FIG. 5 may be determined based on the input and output data partially shown in FIG. 6. In FIG. 6, the classification column corresponds to the categorization of data items determined by an algorithm and features 1-4 correspond to attributes of each data item. In some embodiments, the decision tree may be determined by the system in step 202 of FIG. 2 or during layer 2 of FIG. 3 based on the input and output data in FIG. 5.

In FIG. 5, the decision tree comprises nodes each corresponding to a feature of the input data set shown in FIG. 6 and a threshold value. For example, the system may determine that data items can take one of two paths depending on whether the value of feature 1 is lesser than or greater or equal to 50. As shown in FIG. 5, a decision path of a data item may include only a subset of all features. For example, for items classified in the 0.6-0.8 range, only features 1, 2, and 3 are relevant to the categorization. In some embodiments, an attribute/feature may be associated with multiple nodes on different branches of the decision tree. FIGS. 5 and 6 are provided as an example for illustration only, the systems and methods described herein may be applied to a variety of data having any number of features/attributes with decision trees having any number of nodes and leaves.

Next referring to FIG. 7, a graphical user interface according to some embodiments is shown. The user interface shown in FIG. 7 is an example output of the explanation system as applied to job applications. The user interface provides a list of job candidates and an algorithm-determined assessment of how well each candidate fits the job. In some embodiments, the assessment may be a text description (e.g. excellent, good, fair, poor) or a score (e.g. 1, 2, 3). A user may select one or more candidates to view the system-generated natural language explanation of the algorithm assessment. For example, the explanation provides a list of pros (e.g. between 3 and 5 years of grocery experience”) and cons (e.g. “average of 5 months in each prior company”) describing how relevant attributes affected the assessment of that particular candidate. These natural language explanation descriptions may be generated based on the methods and processes described with reference to FIGS. 2-4 herein. In some embodiments, the explanations may be generated as the categorization data are generated by the black box algorithm. In some embodiments, the explanations may be generated on-demand, in response to the data item being selected by the user. The user interface may further comprise a feedback mechanism that allows users to provide feedback on the natural language explanation. The feedback may be used to adjust the various models and templates used in generating the natural language explanation described herein.

Machine Learning (ML) is now increasingly supporting high-consequence human decisions. However, the effectiveness of ML systems can be limited by the inability to explain the inner workings of AL algorithms to human users. The lack of transparency can also reduce trust and discourage the use of ML systems. Moreover, when an ML system produces unexpected or erroneous output, troubleshooting can be difficult.

In some embodiments, systems and methods provided herein may create natural language text explanation for classification scores created by a machine learning algorithm based on the input and output data of the machine learning algorithm. In some embodiments, a system that uses the machine learning algorithm to generate scores can redirect the input and output data of the ML algorithm to an explanation system to generate natural language explanation for the ML-generated categorization (e.g. ranking, scoring) in real-time or near real-time.

In some embodiments, the systems and methods described herein provide an embedded explanation system within an ML/AI System that provides real-time explanations to end users via an automated input/output translation of mathematical algorithms into natural language description. The explanation system may be applied to various types of data and/or various business areas. In some embodiments, the system may be implemented inside an existing ML system that uses tabular data. In some embodiments, the system architecture allows explanation creation and integration, even if the algorithm in production is changed in the future.

In some embodiments, the explanation system is configured to explain decisions made by another system (e.g. ML system) that uses Machine Learning/AI to make a decision. In some embodiments, the explanation may be provided based on communications between the two systems over a network in real-time which use the same data and work together in tandem. In some embodiments, the backend of the explanation system may be a pre-trained, tree-based, machine learning algorithm that helps create explanations for the decision/output of the ML system. In some embodiments, the explanation system may send the explanations back to the ML system which can then opt to show the explanation to the users of the ML system.

In some embodiments, the explanation algorithm may first gather historical data about the inputs and outputs of the ML system. In some embodiments, the explanation may simulate data that is passed to the ML system and record the respective outputs. In some embodiments, a tree-based algorithm and a linear/logistic regression model are trained on the input and output data of the ML system data collected. In some embodiments, the linear/logistic regression model reveals the positive/negative impact of each variable. In some embodiments, the tree-based algorithm reveals decision paths with regard to how a particular decision point has been reached. In some embodiments, both results of the linear/logistic regression model and the tree-based algorithm are utilized in the automatic natural language translation mechanism.

In some embodiments, the explanation system combines a global explanation (generated by linear regression) and a local explanation (generated by a decision tree model) to provide natural language explanation of a single data item's ML result. For example, a natural language explanation may describe why a particular transaction has a different ML result than other transactions and whether each important feature of the data item has a positive impact or negative impact on its ML result.

In one embodiment, a method for providing natural language explanation to black-box algorithm generated outcome comprises accessing an input data database storing input data comprising a plurality of data items, each data item comprises a plurality of attributes, and an output data database storing output data comprising categorizations of the plurality of data items determined by an algorithm based on attributes of the plurality of data items, determining, with a control circuit, a regression coefficient for each of the plurality of attributes based on performing regression analysis on the output data, determining, with the control circuit, a decision tree based on the input data and the output data, the decision tree comprises a plurality of nodes each associated with an attribute of the plurality of attributes, determining, with the control circuit, a decision path of a select data item in the decision tree, the decision path comprises a subset of the plurality of nodes corresponding to relevant attributes of the select data item, generating, with the control circuit, natural language explanation of a categorization of the select data item based on the relevant attributes and regression coefficients associated with each of the relevant attributes, wherein the natural language explanation identifies at least one relevant attribute and an effect of the at least one relevant attribute of the data item on the categorization, and transmitting to a user interface device for display, the categorization of the select data item along with the natural language explanation of the categorization of the select data.

In one embodiment, an apparatus for providing natural language explanation to black-box algorithm generated outcome comprises a non-transitory storage medium storing a set of computer readable instructions and a control circuit configured to execute the set of computer readable instructions which cause to the control circuit to access an input data database storing input data comprising a plurality of data items, each data item comprises a plurality of attributes, and an output data database storing output data comprising categorizations of the plurality of data items determined by an algorithm based on attributes of the plurality of data items, determine a regression coefficient for each of the plurality of attributes based on performing regression analysis on the output data, determine a decision tree based on the input data and the output data, the decision tree comprises a plurality of nodes each associated with an attribute of the plurality of attributes, determine a decision path of a select data item in the decision tree, the decision path comprises a subset of the plurality of nodes corresponding to relevant attributes of the select data item, generate natural language explanation of a categorization of the select data item based on the relevant attributes and regression coefficients associated with each of the relevant attributes, wherein the natural language explanation identifies at least one relevant attribute and an effect of the at least one relevant attribute of the data item on the categorization, and transmit to a user interface device for display, the categorization of the select data item along with the natural language explanation of the categorization of the select data.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system for providing natural language explanation to black-box algorithm generated outcome comprising:
an input data database storing input data comprising a plurality of data items, each data item comprises a plurality of attributes;
an output data database storing output data comprising categorizations of the plurality of data items determined by an algorithm based on attributes of the plurality of data items; and
a control circuit coupled to the input data database and the output data database, the control circuit being configured to:
determine a regression coefficient for each of the plurality of attributes based on performing regression analysis on the output data;
determine a decision tree based on the input data and the output data, the decision tree comprises a plurality of nodes each associated with an attribute of the plurality of attributes;
determine a decision path of a select data item in the decision tree, the decision path comprises a subset of the plurality of nodes corresponding to relevant attributes of the select data item;
generate natural language explanation of a categorization of the select data item based on the relevant attributes and regression coefficients associated with each of the relevant attributes, wherein the natural language explanation identifies at least one relevant attribute and an effect of the at least one relevant attribute of the data item on the categorization; and
transmit to a user interface device for display, the categorization of the select data item along with the natural language explanation of the categorization of the select data.

2. The system of claim 1, wherein the effect of the at least one relevant attribute of the data item on the categorization is determined based on the regression coefficient of the at least one relevant attribute and comparing a value of the at least one relevant attribute of the data item with a comparison value of the at least one relevant attribute in the input data database.

3. The system of claim 1, wherein the regression coefficient comprises a sign indicating whether the attribute has a positive or negative effect on the categorization of the data item and a numerical value indicating a significance of the attribute.

4. The system of claim 1, wherein regression coefficients of numerical attributes are determined based on linear regression and regression coefficients of categorical attributes are determined based on logistic regression.

5. The system of claim 1, wherein the natural language explanation comprises a list of positive attributes and a list of negative contributes sorted based on whether the attributes affected the categorization of the select data positively or negatively.

6. The system of claim 1, wherein the control circuit is further configured to:
access an explanation text table comprising text strings associated with each of the plurality of attributes, wherein one or more attributes are associated with a plurality of text strings; and
select from the plurality of text strings associated with the at least one relevant attribute based on how the attribute affects the categorization of the select data.

7. The system of claim 6, wherein one or more text strings in the explanation text table comprises a value field, and the control circuit is configured to populate the value field of a selected text string based on a value of the at least one relevant attribute of the data item.

8. The system of claim 1, wherein the decision tree is determined based on a classification and regression tree (CART) algorithm or a Chi-square automatic interaction detection (CHAID) algorithm.

9. The system of claim 1, wherein the input data comprises job applicant data the output data comprises rankings of applicants.

10. The system of claim 1, wherein the algorithm comprises a black-box machine learning or artificial intelligence algorithm.

11. A method for providing natural language explanation to black-box algorithm generated outcome comprising:
accessing an input data database storing input data comprising a plurality of data items, each data item comprises a plurality of attributes, and an output data database storing output data comprising categorizations of the plurality of data items determined by an algorithm based on attributes of the plurality of data items;
determining, with a control circuit, a regression coefficient for each of the plurality of attributes based on performing regression analysis on the output data;
determining, with the control circuit, a decision tree based on the input data and the output data, the decision tree comprises a plurality of nodes each associated with an attribute of the plurality of attributes;
determining, with the control circuit, a decision path of a select data item in the decision tree, the decision path comprises a subset of the plurality of nodes corresponding to relevant attributes of the select data item;
generating, with the control circuit, natural language explanation of a categorization of the select data item based on the relevant attributes and regression coefficients associated with each of the relevant attributes, wherein the natural language explanation identifies at least one relevant attribute and an effect of the at least one relevant attribute of the data item on the categorization; and
transmitting to a user interface device for display, the categorization of the select data item along with the natural language explanation of the categorization of the select data.

12. The method of claim 11, wherein the effect of the at least one relevant attribute of the data item on the categorization is determined based on the regression coefficient of the at least one relevant attribute and comparing a value of the at least one relevant attribute of the data item with a comparison value of the at least one relevant attribute in the input data database.

13. The method of claim 11, wherein the regression coefficient comprises a sign indicating whether the attribute has a positive or negative effect on the categorization of the data item and a numerical value indicating a significance of the attribute.

14. The method of claim 11, wherein regression coefficients of numerical attributes are determined based on linear regression and regression coefficients of categorical attributes are determined based on logistic regression.

15. The method of claim 11, wherein the natural language explanation comprises a list of positive attributes and a list of negative contributes sorted based on whether the attributes affected the categorization of the select data positively or negatively.

16. The method of claim 11, wherein the control circuit is further configured to:
access an explanation text table comprising text strings associated with each of the plurality of attributes, wherein one or more attributes are associated with a plurality of text strings; and
select from the plurality of text strings associated with the at least one relevant attribute based on how the attribute affects the categorization of the select data.

17. The method of claim 16, wherein one or more text strings in the explanation text table comprises a value field, and the control circuit is configured to populate the value field of a selected text string based on a value of the at least one relevant attribute of the data item.

18. The method of claim 11, wherein the decision tree is determined based on a classification and regression tree (CART) algorithm or a Chi-square automatic interaction detection (CHAID) algorithm.

19. The method of claim 11, wherein the input data comprises job applicant data the output data comprises rankings of applicants.

20. An apparatus for providing natural language explanation to black-box algorithm generated outcome comprising:
a non-transitory storage medium storing a set of computer readable instructions; and
a control circuit configured to execute the set of computer readable instructions which cause to the control circuit to:
access an input data database storing input data comprising a plurality of data items, each data item comprises a plurality of attributes, and an output data database storing output data comprising categorizations of the plurality of data items determined by an algorithm based on attributes of the plurality of data items;
determine a regression coefficient for each of the plurality of attributes based on performing regression analysis on the output data;
determine a decision tree based on the input data and the output data, the decision tree comprises a plurality of nodes each associated with an attribute of the plurality of attributes;
determine a decision path of a select data item in the decision tree, the decision path comprises a subset of the plurality of nodes corresponding to relevant attributes of the select data item;
generate natural language explanation of a categorization of the select data item based on the relevant attributes and regression coefficients associated with each of the relevant attributes, wherein the natural language explanation identifies at least one relevant attribute and an effect of the at least one relevant attribute of the data item on the categorization; and
transmit to a user interface device for display, the categorization of the select data item along with the natural language explanation of the categorization of the select data.
